(19) United States
(12) Patent Application Publication
(10) Pub. No.: US 2013/0181557 A1
(43) Pub. Date: Jul. 18, 2013

(54) FLUID INJECTING METHOD AND APPARATUS FOR IMPLEMENTING THE SAME, AND MOTOR MANUFACTURED USING THE SAME

(71) Applicant: Seung Dong KIM, Suwon (KR)

(72) Inventor: Seung Dong KIM, Suwon (KR)

(73) Assignee: SAMSUNG ELECTRO-MECHANICS CO., LTD.

(21) Appl. No.: 13/440,742

(22) Filed: Apr. 5, 2012

(30) Foreign Application Priority Data
Jan. 18, 2012 (KR) 10-2012-0005669

(51) Int. Cl. H02K 7/08; F16C 33/10

(52) U.S. Cl. 310/90; 384/399

(57) ABSTRACT

There are provided a fluid injecting method capable of easily injecting oil into a motor and an apparatus for implementing the same, and a motor manufactured using the same. The fluid injecting method includes: connecting a shaft and a sleeve to each other to thereby assemble a bearing assembly; disposing at least one bearing assembly under a dispenser in a state in which the bearing assembly is tilted at a predetermined angle; and injecting a fluid into the bearing assembly.

### CROSS-REFERENCE TO RELATED APPLICATIONS

This application claims the priority of Korean Patent Application No. 10-2012-0005669 filed on Jan. 18, 2012, in the Korean Intellectual Property Office, the disclosure of which is incorporated herein by reference.

### BACKGROUND OF THE INVENTION

1. Field of the Invention

The present invention relates to a motor, and more particularly, to a fluid injecting method allowing for a fluid to be easily injected into a motor, an apparatus for implementing the same, and a motor manufactured using the same.

2. Description of the Related Art

As recording disk driving device performance is improved, demand for low current driving, low non repeatable run out (NRRO), impact resistance, vibration resistance, and the like, has increased with regard to a small-sized spindle motor used in the recording disk driving device.

In particular, as a spindle motor for a hard disk drive (HDD) is used in various portable products such as netbook computers, mobile phones, portable multimedia players (PMPs), game machines, and the like, research into spindle motor miniaturization has been more actively undertaken.

Generally, a spindle motor is configured of a stator, including a core having a coil wound therearound, and a rotor receiving the stator therein and rotatably installed thereon. In addition, when voltage is applied to the stator coil, electromagnetic force is generated to rotate the rotor, thereby providing rotational force.

In the spindle motor, a lubricating fluid is provided between a sleeve and a shaft in order to supplement dynamic pressure and to prevent friction between the sleeve and the shaft when the shaft rotates. Related art document 1 discloses a fluid injecting process of filling a motor with this lubricating fluid.

Referring to related art document 1, the fluid injecting process according to the related art is configured to inject the oil between the shaft and the sleeve from a dispenser disposed thereabove.

However, in the fluid injecting process according to the related art, the fluid is injected in a state in which a needle of the dispenser injecting the fluid is disposed to be closely adjacent to a circumferential surface of the shaft. Therefore, the fluid injected from the dispenser may be splashed or diffused onto an upper end surface of the shaft, or the like, to deteriorate product reliability.

In addition, since the needle of the dispenser is disposed to be closely adjacent to the shaft, the needle contacts the shaft due to impact, or the like, to damage the needle or the shaft.

### RELATED ART DOCUMENT

Japanese Patent Laid-Open Publication No. 2009-097678

### SUMMARY OF THE INVENTION

An aspect of the present invention provides a fluid injecting method allowing for a fluid to be easily injected into a motor during an injection process thereof, and an apparatus for implementing the same, and a motor manufactured using the same.

According to an aspect of the present invention, there is provided a fluid injecting method including: connecting a shaft and a sleeve to each other to thereby assemble a bearing assembly; disposing at least one bearing assembly under a dispenser in a state in which the bearing assembly is tilted at a predetermined angle; and injecting a fluid into the bearing assembly.

In the disposing of the bearing assembly under the dispenser, the bearing assembly may be disposed to be tilted in a manner in which an interval between a circumferential surface of the shaft and the dispenser is increased.

In the disposing of the bearing assembly under the dispenser, the bearing assembly may be disposed on a stage having an upper surface tilted at a predetermined angle based on a horizontal line.

In the disposing of the bearing assembly under the dispenser, the bearing assembly may be disposed on a stage having at least one seating groove formed in an upper surface thereof.

In the disposing of the bearing assembly under the dispenser, the bearing assembly may be disposed on a stage formed to have a seating groove having a bottom surface tilted at a predetermined angle based on the horizontal line.

In the injecting of the fluid, the fluid may be simultaneously injected into a plurality of the bearing assemblies by a plurality of the dispensers.

According to another aspect of the present invention, there is provided a motor including: the bearing assembly into which the fluid is injected by the fluid injection method as described above; and a rotor coupled to the shaft of the bearing assembly to thereby rotate.

According to another aspect of the present invention, there is provided a fluid injecting apparatus including: a vacuum chamber; at least one dispenser disposed in the vacuum chamber and injecting a fluid into a bearing assembly; and a stage disposing the bearing assembly under the dispenser, wherein the stage supports the bearing assembly so as to be disposed under the dispenser in a state in which the bearing assembly is tilted at a predetermined angle.

The stage may support the bearing assembly so as to be tilted in a state in which an interval between a circumferential surface of a shaft of the bearing assembly and the dispenser is increased.

The stage may have an upper surface tilted at a predetermined angle based on a horizontal line.

The stage may be configured to rotate based on a rotational axis tilted at a predetermined angle based on a vertical line.

The stage may have at least one seating groove formed on an upper surface thereof, and the bearing assembly may be seated in the seating groove.

An upper surface of the stage may be formed to have at least one seating groove having a tilted bottom surface, and the bearing assembly may be seated in the seating groove.

The stage may include: a supporting plate supporting the bearing assembly; and a rotating table coupled to a lower portion of the supporting plate to thereby rotate the supporting plate.

According to another aspect of the present invention, there is provided a motor including: the bearing assembly into which the fluid is injected by the fluid injecting apparatus as described above; and a rotor coupled to the bearing assembly to thereby rotate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partial cross-sectional view schematically showing a motor according to an embodiment of the present invention;

FIG. 2 is a cross-sectional view describing a fluid injecting method according to the embodiment of the present invention;

FIG. 3 is a cross-sectional view schematically showing a fluid injecting apparatus according to the embodiment of the present invention;

FIG. 4 is a cross-sectional view schematically showing a fluid injecting apparatus according to another embodiment of the present invention; and

FIG. 5 is a cross-sectional view schematically showing the fluid injecting apparatus according to another embodiment of the present invention.

### DETAILED DESCRIPTION OF THE EMBODIMENTS

The terms and words used in the present specification and claims should not be interpreted as being limited to typical meanings or dictionary definitions thereof, but should be interpreted as having meanings and concepts relevant to the technical scope of the present invention, based on the rule according to which an inventor can appropriately define the concept of the term to appropriately describe the method he or she knows for carrying out the invention. Therefore, the configurations described in the embodiments and drawings of the present invention are merely the embodiments and do not represent all of the technical spirit of the present invention. Thus, the present invention should be construed as including all the changes, equivalents, and substitutions included in the spirit and scope of the present invention at the time of filing this application.

Hereinafter, embodiments of the present invention will be described in detail with reference to the accompanying drawings. At this time, it is noted that like reference numerals denote like elements in appreciating the drawings. Moreover, detailed descriptions related to well-known functions or configurations will be ruled out in order not to unnecessarily obscure the subject matter of the present invention. Based on the same reason, it is to be noted that some components shown in the drawings are exaggerated, omitted or schematically illustrated, and the depicted size of individual component may not exactly reflect its actual size.

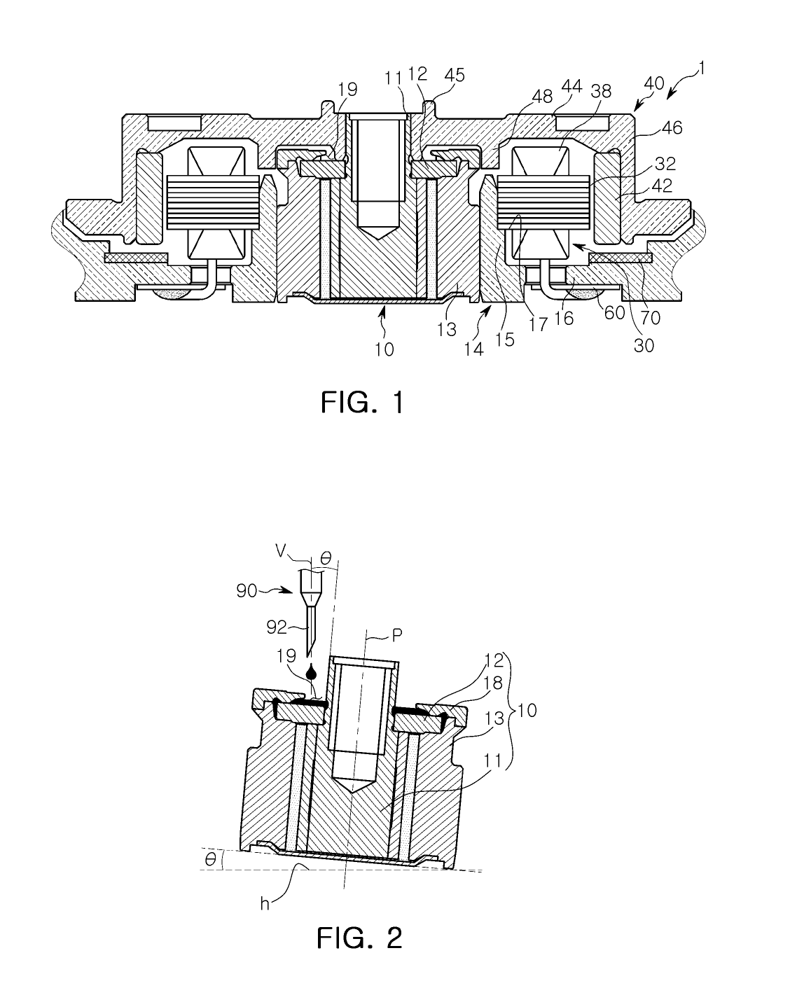

Meanwhile, terms with respect to directions will be defined. As viewed in FIG. 1, an axial direction refers to a vertical direction based on a shaft 11, and an outer diameter or inner diameter direction refers to a direction toward an outer edge of a rotor 40, based on the shaft 11, or a direction toward the center of the shaft 11, based on the outer edge of the rotor 40.

Hereinafter, embodiments of the present invention will be described in detail with reference to the accompanying drawings.

FIG. 1 is a partial cross-sectional view schematically showing a motor according to an embodiment of the present invention.

Referring to FIG. 1, the motor 1 according to the present embodiment, a spindle motor 1 used in a hard disk drive (HDD), may include a bearing assembly 10, a base 14 having a circuit board 60 attached thereto, a stator 30, and a rotor 40.

The bearing assembly 10 may include a shaft 11, a thrust plate 12, and a sleeve 13.

The shaft 11 may form a rotational axis of the rotor 40 to be described below. The shaft 11 may be inserted into the sleeve 13 and rotate, and may have a screw separately assembled on an upper surface thereof so as to be screwed to a rotor hub 45 to be described below.

In addition, the shaft 11 may be manufactured to have an increased thickness in a portion at which the sleeve 13 is coupled thereto rather than in a portion at which the rotor hub 45 is coupled thereto, so that the rotor hub 45 and a thrust plate 12 to be described below may be seated thereon in parallel with each other, to thereby be stepped thereon.

The thrust plate 12 maybe fixedly coupled to the shaft 11 so as to be disposed on an upper surface of the sleeve 13, and prevented from moving upwardly by a cap 18.

The thrust plate 12 maybe disposed in a manner in which it is interposed between the rotor hub 45 and an upper end surface of the sleeve 13, and may have an annular donut shape on the upper end surface of the sleeve 13.

In the present embodiment, although the thrust plate 12 is manufactured separately from the shaft 11 and is then coupled thereto, the present invention is not limited thereto. That is, the thrust plate 12 may be formed integrally with the shaft 11.

The cap 18 may cover an outer peripheral surface and one side of the thrust plate 12 so as to form a hydrodynamic bearing space between the cap 18 and the outer peripheral surface of the thrust plate 12 and may be fixedly coupled to one side of the sleeve 13.

The sleeve 13 is a rotating support member having the shaft 11 inserted into a hole formed therein and supporting the shaft 11 while forming an oil film between the sleeve 13 and the shaft 11 so that the shaft 11 may easily rotate. To this end, any one of an outer peripheral part of the shaft 11 and an inner peripheral part of the sleeve 13 may be formed to have a plurality of radial dynamic pressure grooves (not shown) generating hydrodynamic pressure.

The sleeve 13 may be assembled in a manner in which a lower portion of a body thereof is press-fitted into a sleeve supporting part 15 of the base 14, as shown in FIG. 1.

The sleeve 13 and the shaft 11 may include a fluid filled therebetween, the fluid serving as lubricating oil, such that friction between the sleeve 13 and the shaft 11 may be reduced at the time of rotation of the shaft. The sleeve 13 has an outer peripheral surface press-fitted into and fixed to an inner portion of a base 14 to be described below.

Meanwhile, although not shown, at least one of the upper end surface of the sleeve 13 and a lower end surface of the thrust plate 12 may be formed to have a thrust dynamic pressure groove to thereby generate hydrodynamic pressure.

The base 14, a supporting member supporting entire components of the motor 1, may include the sleeve supporting part 15 supporting the shaft 11 so that the shaft 11 may rotate via the sleeve 13 and a plate part 16 having a circuit board 60 to be described below attached to a lower surface thereof.

The sleeve supporting part 15 may be cylindrical and have the sleeve 13 and the shaft 11 inserted into an inner portion thereof. The sleeve supporting part 15 may have a stator 30, to be described below, seated in an outer peripheral surface thereof. To this end, the outer peripheral surface of the sleeve supporting part 15 may be formed to have a seating part 17 partially protruded in the outer diameter direction to thereby form a step.

The circuit board 60 has circuit patterns (not shown) formed therein in order to apply power to the motor 1 and is electrically connected to a winding coil 38 to thereby apply power to the winding coil 38. In addition, a ground pattern among the circuit patterns of the circuit board 60 may be conducted to the base 14. As the circuit board 60, various boards such as a general printed circuit board (PCB), a flexible PCB, or the like, may be selectively used as needed.

The rotor 40 may include a magnet 42 and a rotor case 44.

The magnet 42 may be a ring-shaped permanent magnet generating magnetic force of a predetermined strength by alternately magnetizing an N pole and an S pole thereof in a circumferential direction.

The rotor case 44 may have a cup shape, and may include the rotor hub 45 and a magnet coupling part 46.

The rotor hub 45 may be coupled to an upper end portion of the shaft 11.

The magnet coupling part 46, which has the magnet 42 coupled thereto, is formed along an inner peripheral surface of the rotor case 44. Here, the magnet 42 may be disposed to face a core 32 of a stator 30 to be described below. Therefore, when power is applied to the winding coil 38 wound around the core 32, the rotor 40 may rotate through electromagnetic interaction between the magnet 42 and the winding coil 38.

The stator 30 may be a fixed structure including the core 32 and the winding coil 38 wound around the core 32 and received in the rotor 40.

The core 32 may be formed by stacking a plurality of the steel plates or may be formed of a magnetic material such as ferrite. The core 32 may be radially extended in the outer diameter direction of the shaft 11 based on the shaft 11.

The core 32 may be press-fitted into and fixedly coupled to the outer peripheral surface of the sleeve supporting part 15 of the base 13 so as to contact the outer peripheral surface thereof.

The winding coil 38, a coil wound around a core 32 to be described below, may generate electromagnetic force at the time of the application of power. The winding coil 38 according to the present embodiment may be electrically connected to the circuit board 60 through a wire to thereby receive external power therethrough.

A pulling plate 70 may be mounted on the base 14. The pulling plate 70 may be coupled to the base in a position at which the pulling plate faces the magnet 42 of the rotor 40 in the axial direction to thereby generate magnetic pulling force by interference with the magnet 42. To this end, the pulling plate 70 may be formed of a magnet or a magnetic material and may have a continuous annular ring shape.

In the motor 1 according to the present embodiment configured as described above, the fluid forming an oil film may be filled between the sleeve 13 and the shaft 11. This fluid may be injected into a gap between the shaft 11 and the sleeve 13 after the shaft 11 and the sleeve 13 are coupled to each other.

Hereinafter, a method of manufacturing a motor according to the present embodiment will be described. The method of manufacturing a motor according to the present embodiment has a feature in a method of injecting the fluid. Therefore, in describing the embodiment of the present invention, a description of processes which are the same as processes according to the related art will be omitted, and a fluid injecting process, a feature of the present embodiment, will mainly be described.

FIG. 2 is a cross-sectional view describing a fluid injecting method according to the present embodiment.

The fluid injecting process according to the present embodiment is performed with respect to a bearing assembly 10 rather than a motor 1 in a completed state.

Therefore, before the fluid injecting process is performed, a process of assembling a shaft 11, a thrust plate 12, a sleeve 13, and a cap 18 to thereby form the bearing assembly 10 may be performed.

The bearing assembly 10 may include a fluid injecting hole 19 provided on an upper portion thereof. The fluid injecting hole 19 may be formed as a space between an outer peripheral surface of the shaft 11 and the cap 18 as shown in FIG. 2. Therefore, when a fluid is dispensed into the fluid injecting hole 19, the fluid may flow along inner surfaces of the cap 18 and the sleeve 13 to thereby be filled between the sleeve 13 and the shaft 11.

In addition, the fluid injecting process according to the present embodiment may be performed in a state in which the bearing assembly 10 is tilted at a predetermined angle (θ). That is, as shown in FIG. 2, the fluid is dispensed in a state in which a bottom surface supporting the bearing assembly 10 is tilted at a predetermined angle θ with relation to a horizontal line H.

In this configuration, since a needle 92 of a dispenser 90 is disposed to be perpendicular to the horizontal line H, the needle 92 and the shaft 11 are also disposed to be spaced apart from each other by a predetermined angle corresponding to the angle θ at which the bearing assembly 10 is tilted. In this configuration, the bearing assembly 10 may be disposed to be tilted in a manner in which an interval between a circumferential surface of the shaft 11 and the dispenser 90 is increased.

Therefore, the needle 92 of the dispenser 90 and the circumferential surface of the shaft 11 maybe spaced apart from each other at a relatively maximal interval, whereby a phenomenon in which the fluid dispensed from the dispenser is splashed or diffused onto an upper end surface of the shaft may be significantly reduced. In addition, the interval between the needle 92 of the dispenser 90 and the shaft 11 may be significantly secured, whereby a phenomenon in which the needle 92 of the dispenser 90 contacts the shaft 11 due to impact, or the like, may be suppressed.

In the fluid injecting method of the motor according to the present embodiment as described above, the fluid may be dispensed after the bearing assembly 10 is disposed to be obliquely tilted. To this end, a separate fluid injecting apparatus 100 may be provided.

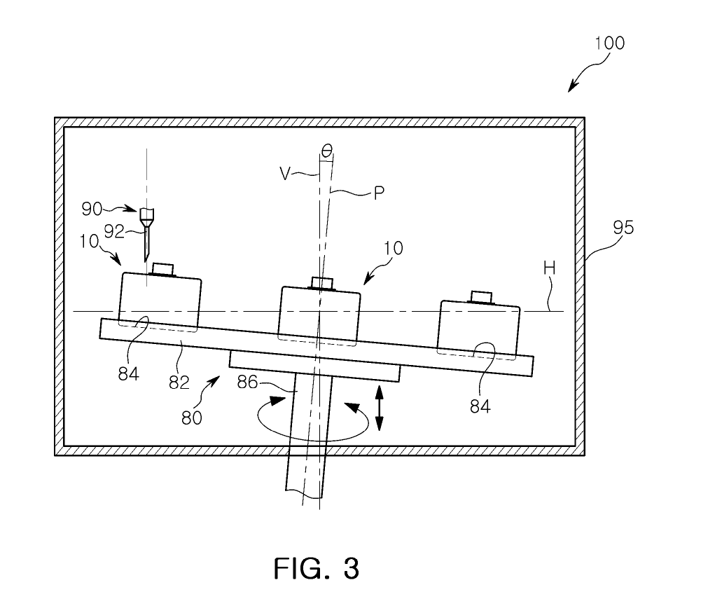

FIG. 3 is a cross-sectional view schematically showing a fluid injecting apparatus according to the present embodiment.

Referring to FIG. 3, the fluid injecting apparatus 100 according to the present embodiment, which is an apparatus for injecting a fluid into a bearing assembly 10 using vacuum, may include a stage 80, a dispenser 90, and a vacuum chamber 95.

The stage 80 may be disposed at an inner portion of the vacuum chamber 95 to be described below and include a supporting plate 82 on which the bearing assembly 10 is seated, and a rotating table 86 connected to the supporting plate 82 to thereby rotate the supporting plate 82. Therefore, the supporting plate 82 may rotate based on a rotational axis P of the rotating table 86. To this end, one end of the rotating table 86 may be provided with a driving source part (not shown) for rotating the rotating table 86.

The supporting plate 82 may include at least one bearing assembly 10 seated in an upper surface thereof. Therefore, the upper surface of the supporting plate 82 may be flat and be formed to have a plurality of seating grooves 84 for fixing the bearing assembly 10 as shown in FIG. 3. As described above, the upper surface of the supporting plate 82 may have various shapes as long as it may stably support the bearing assembly 10.

The stage 80 according to the present embodiment may move in a vertical direction and be configured to easily move to an inner portion and an outer portion of the vacuum chamber 95 to be described. That is, in a case in which the bearing assembly 10 is mounted or removed on the upper surface of the supporting plate 82, the stage 80 may be disposed at the outer portion of the vacuum chamber 95, and in a case in which a process of injecting the fluid in the bearing assembly 10 is performed, the stage 80 may be disposed at the inner portion of the vacuum chamber 95.

In addition, the stage 80 may rotate based on the rotational axis P of the rotating table 86. This is to allow the fluid to be sequentially injected into a plurality of bearing assemblies disposed on the supporting plate 82 while changing positions of the plurality of bearing assemblies 10.

That is, when the dispensing of the fluid on a bearing assembly 10 disposed under the dispenser 90 among bearing assemblies disposed on the supporting plate 82 is completed, the stage 80 rotates by a predetermined angle based on the rotational axis P. Therefore, another bearing assembly 10 may be disposed under the dispenser 90, and the dispensing of the fluid may be repeatedly performed.

Here, as shown in FIG. 3, the rotational axis P of the stage 80 according to the present embodiment may be tilted at a predetermined angle θ with respect to a vertical line V. Therefore, the upper surface of the supporting plate 82 is not disposed to be in parallel with the horizontal line H, but is disposed to be tilted at a predetermined angle θ with respect to the horizontal line H.

All the bearing assemblies 10 seated in the upper surface of the supporting plate 82 are not disposed to be in parallel with the horizontal line H, but are disposed to be tilted at a predetermined angle θ with respect to the horizontal line H.

In addition, in the fluid injecting apparatus 100 according to the present embodiment, since the entire stage 80 rather than only the supporting plate 82 is tilted, the bearing assembly 10 disposed under the dispenser 90 may be disposed while being always maintained in a state in which the bearing assembly 10 is tilted at the same angle at the same position.

The dispenser 90 may be disposed over the stage 80 and have the needle 92 disposed downwardly. The dispenser 90 may dispense the fluid through a distal end of the needle 92. In this case, the dispensed fluid is injected into the bearing assembly 10 disposed under the needle 92.

Therefore, the dispenser 90 may be disposed at a position corresponding to that of the bearing assembly 10 seated in the stage 80. That is, the fluid injecting hole 19 (See FIG. 2) of the bearing assembly 10 may be disposed directly under the needle 92.

The dispenser 90 may have the lubricating fluid therein and timely dispense the fluid downwardly, that is, into the fluid injecting hole 19 of the bearing assembly 10. In the present embodiment, a method of dispensing the fluid in the dispenser 90 is not particularly limited. That is, as needed, various methods such as a volume metering scheme of filling a lubricating fluid in a cylinder and pressurizing the cylinder by a plunger to thereby discharge a predetermined amount of fluid, an ink jet scheme of discharging a fluid by pressurization using a piezoelectric element, or the like, may be used.

As the vacuum chamber 95, which is a closed container including an opening and closing hole for seating the bearing assemblies 10 on the stage 80, a container relatively significantly maintaining vacuum therein may be used.

The vacuum chamber 95 may include various equipments such as a vacuum pump (not shown), an exhaust pipe (not shown), and the like, in order to allow an inner portion thereof to be in a vacuum state.

This vacuum chamber 95 may be provided in order to discharge air existing in the bearing assembly 10, that is, between the sleeve 13 and the shaft 11, to the outside. Therefore, the fluid injected into the fluid injecting hole 19 maybe easily filled in a gap between the sleeve 13 and the shaft 11 while being soaked thereinto.

A process of injecting a fluid into a bearing assembly 10 using the fluid injecting apparatus 100 according to the present embodiment configured as described above will be described.

First, the dispenser 90 filled with a fluid and the bearing assembly 10 may be disposed in the vacuum chamber 95. Here, a plurality of bearing assemblies 10 may be entered into and then be disposed at an inner portion of the vacuum chamber 95 in a state in which they are disposed on an upper surface of the stage 80.

Next, the inner portion of the vacuum chamber 95 becomes a vacuum state using a vacuum pump (not shown). Therefore, air occupying a gap between the sleeve 13 and the shaft 11 is also discharged to the outside.

In addition, when the inner portion of the vacuum chamber 95 reaches a predetermined vacuum level, the dispenser 90 dispenses the fluid. Therefore, the dispensed fluid is injected into the fluid injecting hole 19 of the bearing assembly 10 disposed under the dispenser 90.

Here, as described above, the bearing assembly 10 according to the present embodiment may be disposed on the supporting plate 82 of which a bottom surface is tilted at a predetermined angle with respect to the horizontal line (H). Therefore, the needle 92 of the dispenser 90 and the shaft 11 of the bearing assembly 10 are spaced apart from each other, so that a phenomenon in which the dispensed fluid is splashed or diffused to the upper end of the shaft 11, or the like, may be significantly reduced.

Meanwhile, a process of dispensing the fluid may be sequentially performed with respect to all the bearing assemblies 10 disposed on the stage 80. That is, as described above, the stage 80 sequentially disposes the bearing assemblies 10 under the dispenser 90 while rotating along the rotational axis P, such that the fluid may be dispensed in all the bearing assemblies 10.

When the dispensing of the fluid with respect to all the bearing assemblies 10 is completed, the vacuum level of the inner portion of the vacuum chamber 95 may be slowly reduced. Therefore, the fluid injected into the bearing assembly 10 may be filled in a gap between the sleeve 13 and the shaft 11 while penetrating thereinto due to increased pressure.

Therefore, the fluid injecting process in the method for manufacturing a motor 1 according to the present embodiment is completed.

In the fluid injecting method according to the present embodiment, the bearing assemblies 10 may be disposed at the inner portion of the vacuum chamber 95 in a state in which they are tilted at a predetermined angle by the fluid injecting apparatus 100 according to the present embodiment.

Therefore, the fluid may be injected in a state in which the needle 92 of the dispenser 90 and the shaft 11 of the bearing assembly 10 are relatively significantly spaced apart from each other. Therefore, a phenomenon that the fluid is splashed or diffused to the upper portion of the shaft 11, or the like, during a process of injecting a fluid may be significantly reduced.

Meanwhile, the fluid injecting method and the apparatus used in the same according to the embodiment of the present invention are not limited to the above-mentioned embodiments, but may be variously applied. A fluid injecting apparatus according to embodiments to be described below has a structure similar to that of the fluid injecting apparatus 100 (See FIG. 3) according to the above-mentioned embodiment and is different only in terms of a structure of a dispenser or a stage therefrom. Accordingly, a detailed description of the same components will be omitted, and the structure of the dispenser or the stage will mainly be described in more detail. In addition, the same reference numerals will be used to describe the same components as those of the above-mentioned embodiment.

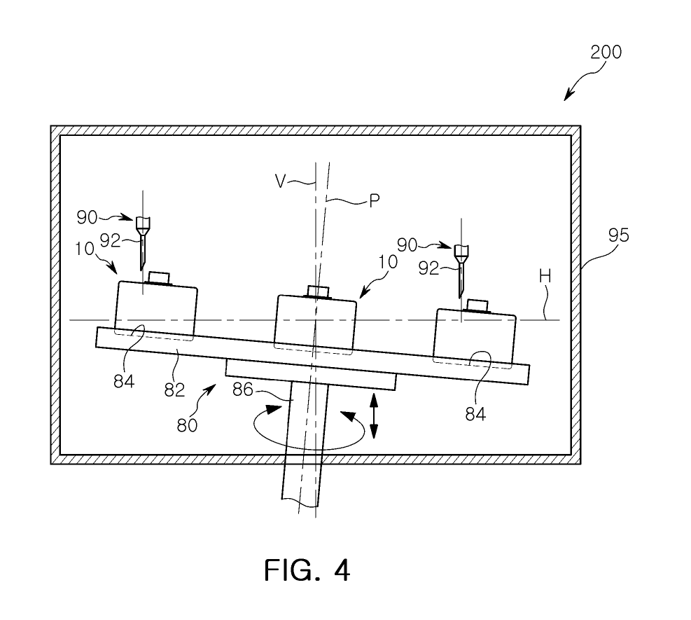

FIG. 4 is a cross-sectional view schematically showing a fluid injecting apparatus according to another embodiment of the present invention.

Referring to FIG. 4, in a fluid injecting apparatus 200 according to the present embodiment, a case in which a plurality of the dispensers 90 are disposed in a vacuum chamber 95 is described by way of example.

In the case in which the plurality of dispensers 90 are provided as described above, a fluid may be simultaneously dispensed to a plurality of bearing assemblies 10. Therefore, a manufacturing time required to inject the fluid may be significantly reduced.

Meanwhile, although the present embodiment has described a case in which two dispensers 90 are provided by way of example, the present invention is not limited thereto. That is, two or more dispensers 90 may be provided as needed. For example, a number of dispensers 90 the same as that of bearing assemblies 10 disposed on a stage 80 may be provided.

In this case, since the dispensing of the fluid to all of the bearing assemblies 10 is completed only on a one-time dispensing process, the stage 80 does not need to rotate. Therefore, in this case, a separate driving source for rotating the rotating table 86 or the stage 80 may be omitted.

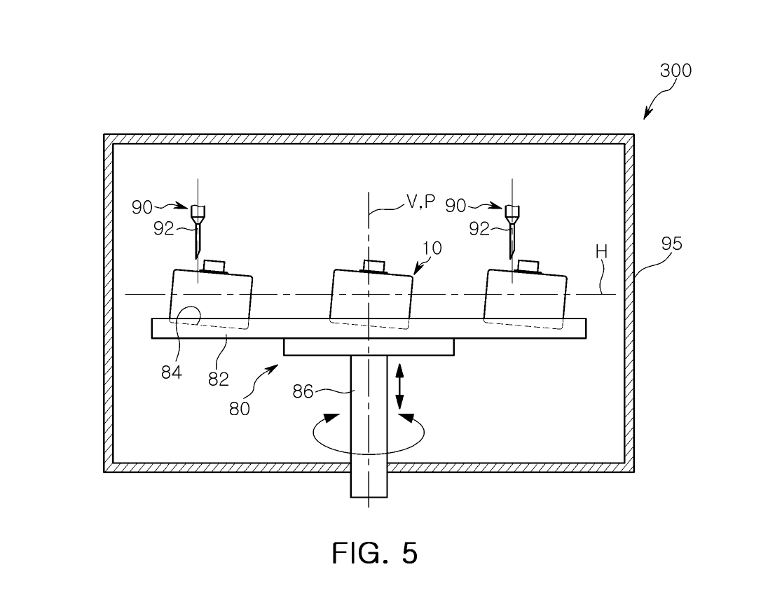

FIG. 5 is a cross-sectional view schematically showing a fluid injecting apparatus according to another embodiment of the present invention.

Referring to FIG. 5, in a fluid injecting apparatus 300 according to the present embodiment, a case in which an upper surface of a supporting plate 82 is disposed to be in parallel with a horizontal line H and a rotational axis P of a rotating table 86 is also disposed to be in parallel with a vertical line V is described by way of example.

A stage 80 according to the embodiment of the present invention may include a plurality of seating grooves 84 formed in an upper surface of the supporting plate 82, wherein each of the plurality of seating grooves 84 has bearing assemblies 10 seated thereon. Particularly, the seating grooves 84 according to the present embodiment may have a tilted bottom surface.

Therefore, the bearing assemblies 10 seated in the seating grooves 84 may be disposed in a state in which they are tilted at a predetermined angle according to a tilt of the bottom surface. That is, a shaft 11 of the bearing assembly 10 may be disposed to be tilted at a predetermined angle in a manner in which it is separated from a dispenser 90, such that the shaft 11 and a needle 92 of the dispenser 90 are spaced apart from each other by a predetermined interval. Therefore, the same effect as that of the above-mentioned embodiment may be obtained.

Meanwhile, although not shown, similar to the case of FIG. 4, various applications may be applied. For example, the fluid injecting apparatus 300 according to the present embodiment may also be configured to include a plurality of the dispensers 90.

The fluid injection method, the apparatus for implementing the same, and the motor manufactured using the same according to the embodiments of the present invention are not limited to the above-mentioned embodiments, but may be variously applied. For example, although the above-mentioned embodiments have described a case in which the bearing assembly is tilted at a predetermined angle by way of example, the present invention is not limited thereto. That is, various applications may be applied as needed. For example, the needle of the dispenser may be configured to be tilted at a predetermined angle with respect to the vertical line, such that the needle and the shaft of the bearing assembly are spaced apart from each other by a predetermined interval.

In addition, although the above-mentioned embodiments have described a case in which the bearing assembly is configured by assembling the shaft, the sleeve, the thrust plate, and the cap by way of example, the present invention is not limited thereto. That is, as required, the bearing assembly may further include the base or the stator or include only the shaft and the sleeve without the thrust plate and the cap according to a shape of the motor. That is, the bearing assembly may have various shapes as long as it may include the fluid injection hole and inject the fluid through the fluid injecting hole.

In addition, although the above-mentioned embodiments have described a case in which the stage moves vertically and rotates, such that the bearing assembly is disposed under the dispenser, the present invention is not limited thereto. That is, various applications may be applied as needed. For example, the dispenser may move vertically and rotate, such that the dispenser moves to an upper portion of the bearing assembly to thereby be disposed over the bearing assembly.

In addition, although the above-mentioned embodiments have described the method and apparatus for injecting the fluid into the bearing assembly of the motor by way of example, the present invention is not limited thereto. That is, the manufacturing method or apparatus according to the embodiment of the present invention may be easily applied to any component in which the fluid is filled or in any device including the component.

As set forth above, with the fluid injecting method according to the embodiment of the present invention, the bearing assemblies may be disposed at the inner portion of the vacuum chamber in a state in which they are tilted at a predetermined angle.

Therefore, the fluid may be injected in a state in which the needle of the dispenser and the shaft of the bearing assembly are relatively significantly spaced apart from each other, whereby a phenomenon in which a fluid is diffused or splashed onto an upper portion of the shaft during a process of injecting a fluid may be significantly reduced.

In addition, an interval between the needle of the dispenser and the shaft may be significantly secured, whereby a phenomenon that the needle of the dispenser is damaged due to contact between the needle of the dispenser and the shaft caused by impact, or the like, may be suppressed.

While the present invention has been shown and described in connection with the embodiments, it will be apparent to those skilled in the art that modifications and variations can be made without departing from the spirit and scope of the invention as defined by the appended claims.

What is claimed is:

1. A fluid injecting method comprising:
connecting a shaft and a sleeve to each other to thereby assemble a bearing assembly;
disposing at least one bearing assembly under a dispenser in a state in which the bearing assembly is tilted at a predetermined angle; and
injecting a fluid into the bearing assembly.

2. The fluid injecting method of claim 1, wherein in the disposing of the bearing assembly under the dispenser, the bearing assembly is disposed to be tilted in a manner in which an interval between a circumferential surface of the shaft and the dispenser is increased.

3. The fluid injecting method of claim 1, wherein in the disposing of the bearing assembly under the dispenser, the bearing assembly is disposed on a stage having an upper surface tilted at a predetermined angle based on a horizontal line.

4. The fluid injecting method of claim 1, wherein in the disposing of the bearing assembly under the dispenser, the bearing assembly is disposed on a stage having at least one seating groove formed in an upper surface thereof.

5. The fluid injecting method of claim 1, wherein in the disposing of the bearing assembly under the dispenser, the bearing assembly is disposed on a stage formed to have a seating groove having a bottom surface tilted at a predetermined angle based on the horizontal line.

6. The fluid injecting method of claim 1, wherein in the injecting of the fluid, the fluid is simultaneously injected into a plurality of the bearing assemblies by a plurality of the dispensers.

7. A motor comprising:
the bearing assembly having the fluid injected by the fluid injection method of claim 1; and
a rotor coupled to the shaft of the bearing assembly to thereby rotate.

8. A fluid injecting apparatus comprising:
a vacuum chamber;
at least one dispenser disposed in the vacuum chamber and injecting a fluid into a bearing assembly; and
a stage disposing the bearing assembly under the dispenser,
the stage supporting the bearing assembly so as to be disposed under the dispenser in a state in which the bearing assembly is tilted at a predetermined angle.

9. The fluid injecting apparatus of claim 8, wherein the stage supports the bearing assembly so as to be tilted in a state in which an interval between a circumferential surface of a shaft of the bearing assembly and the dispenser is increased.

10. The fluid injecting apparatus of claim 8, wherein the stage has an upper surface tilted at a predetermined angle based on a horizontal line.

11. The fluid injecting apparatus of claim 8, wherein the stage is configured to rotate based on a rotational axis tilted at a predetermined angle based on a vertical line.

12. The fluid injecting apparatus of claim 8, wherein the stage has at least one seating groove formed on an upper surface thereof, and the bearing assembly is seated in the seating groove.

13. The fluid injecting apparatus of claim 8, wherein an upper surface of the stage is formed to have at least one seating groove having a tilted bottom surface, and the bearing assembly is seated in the seating groove.

14. The fluid injecting apparatus of claim 8, wherein the stage includes:
a supporting plate supporting the bearing assembly; and
a rotating table coupled to a lower portion of the supporting plate to thereby rotate the supporting plate.

15. A motor comprising:
the bearing assembly having the fluid injected by the fluid injecting apparatus of claim 8; and
a rotor coupled to the bearing assembly to thereby rotate.
